(19) United States
(12) Patent Application Publication
(10) Pub. No.: US 2008/0289648 A1
(43) Pub. Date: Nov. 27, 2008

(54) Dental floss holder with improved structure

(76) Inventor: Nickolas Liu, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/889,718

(22) Filed: Aug. 15, 2007

(30) Foreign Application Priority Data
May 24, 2007 (TW) 096208501

(51) Int. Cl. A61C 15/04

(52) U.S. Cl. 132/322; 132/325

(57) ABSTRACT

A dental floss holder with improved structure includes a main body, a restraining apparatus for tightening dental floss, a hollow shaft portion, a releasing apparatus, a clean portion having a pair of U-shaped fork arms for cleaning teeth, a connecting arm for connecting the main body and the clean portion, and dental floss, wherein the main body includes an assembly portion assembled and communicating with a supply portion adapted for accommodating dental floss, and a bottom case covering the main body. The assembly portion defines an axial hole thereon. The restraining apparatus is assembled on the assembly portion with a hollow post inserted through the axial hole. The hollow shaft portion is rotatably mounted to the hollow post in the assembly portion. The releasing apparatus disposed on the bottom case for releasing the dental floss to be replaced.

### BACKGROUND OF THE INVENTION

1. Field of the Invention

The present invention relates to devices for storing and manipulating dental floss for cleaning a person's teeth, particularly to an a dental floss holder with improved structure which is manipulated by mechanical means to clean teeth and can be used repeatedly.

2. Related Art

As is well known, oral hygiene is very important. A basic approach to maintain a well oral hygiene is to brush teeth after every meal. However, it is difficult to brush teeth everywhere after a meal and is not easy to scale the teeth by brushing. Therefore, for the importance of oral hygiene, dentists appeal to everyone to brush teeth cooperatively with picking teeth by dental floss. Conventional dental floss holder is generally classified to two types: one is spooling type and the other one is Y-shaped type; dental floss of the preceding type is reeled in a spool, when use, users have to draw the floss and tighten the floss up to scale teeth; in this way to clean teeth particularly requires cleanness of hands, or oral hygiene may be affected; besides rear molar teeth are difficult to clean in this way since manipulation angles.

As to the Y-shaped dental floss holder, dental floss of the Y-shaped holder is being fixed on a gap of the Y-shaped holder, when use, users can put the gap of the Y-shaped holder into a mouth without using the users' finger inside the mouth; therefore, the finger will not touch floss directly. However, rear molar teeth are still hard to be cleaned due to the manipulation angles of using the Y-shaped dental floss holder. Furthermore, the Y-shaped dental floss holder is usually thrown away after cleaning, which may cause garbage pollution and waste resources; so, aforementioned two types of dental floss holder need to be improved.

### SUMMARY OF THE INVENTION

Accordingly, an object of the present invention is to provide a dental floss holder with improved structure which is able to easily manipulate, replace, and repeatedly use dental floss, and to accommodate different sizes of dental floss boxes.

Further object of the present invention is to provide a dental floss holder, which enables users to manipulate without putting the users' finger into the mouth and can clean rear molar teeth to keep well oral hygiene.

To achieve the above-mentioned objects, a dental floss holder with improved structure includes a main body, a restraining apparatus for tightening dental floss, a hollow shaft portion, a releasing apparatus, a clean portion having a pair of U-shaped fork arms for cleaning teeth, a connecting arm for connecting the main body and the clean portion, and dental floss, wherein the main body includes an assembly portion assembled and communicating with a supply portion adapted for accommodating dental floss, and a bottom case covering the main body. The assembly portion defines an axial hole thereon. The restraining apparatus is assembled on the assembly portion with a hollow post inserted through the axial hole. The hollow shaft portion is rotatably mounted to the hollow post in the assembly portion. The releasing apparatus disposed on the bottom case for releasing the dental floss to be replaced.

### BRIEF DESCRIPTION OF THE DRAWINGS

FIG. 1 is an exploded perspective view of a dental floss holder with improved structure of the first embodiment of the present invention;

FIG. 2 is an assembly view of FIG. 1;

FIG. 3 is a partially cutaway view showing a restraining apparatus, a hollow shaft portion and a releasing apparatus of the present invention;

FIG. 4 is another side view of FIG. 2;

FIG. 5 is a partially perspective view of the present invention showing a protrusion of a releasing bar is not in engagement with zigzag grooves;

FIG. 6 is a top plan view showing a route of dental floss of the present invention;

FIG. 7 is an assembly perspective view of the dental floss holder with improved structure of the second embodiment of the present invention;

FIG. 8 is the dental floss holder of FIG. 7 accommodating a dental floss box;

FIG. 9 is the dental floss holder of FIG. 7 accommodating a different size of the dental floss box; and

FIG. 10 is a schematic view of the dental floss holder with improved structure of the third embodiment of the present invention.

### DESCRIPTION OF THE PREFERRED EMBODIMENTS

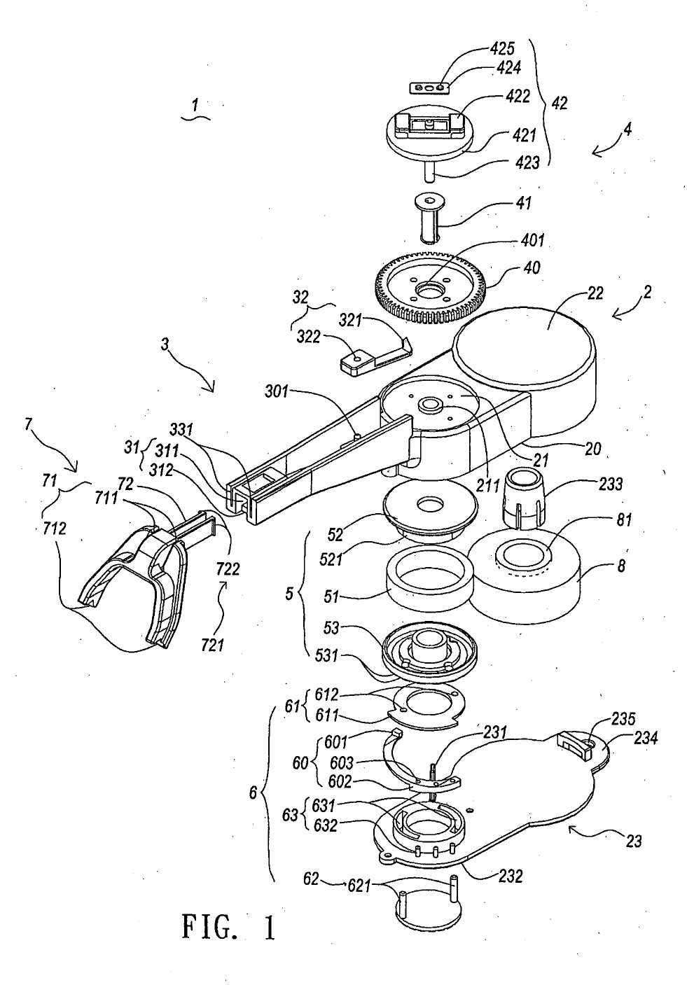

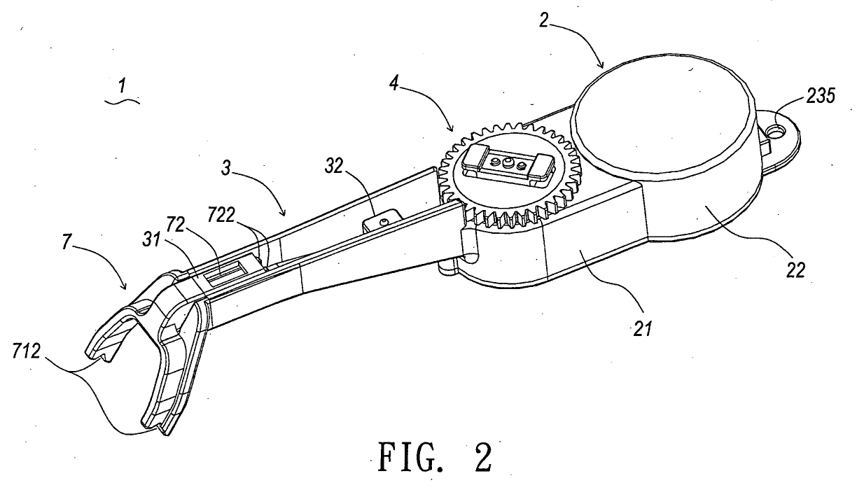

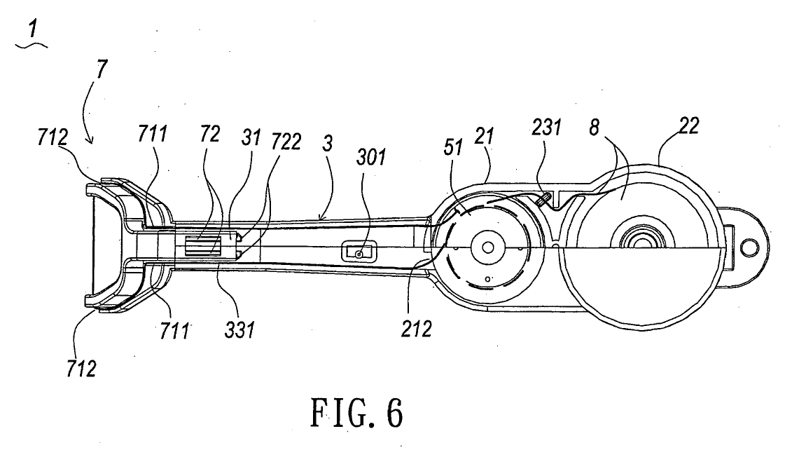

With reference to FIGS. 1 and 2, a dental floss holder with improved structure 1 includes: a main body 2, a connecting arm 3, a restraining apparatus 4, a hollow shaft portion 5, a releasing apparatus 6, a clean portion 7, and dental floss 8, wherein the main body 2 is a case of an opening 20 opened downwardly and includes an assembly portion 21 assembled and communicating with a supply portion 22 adapted for accommodating the dental floss 8. A bottom case 23 corresponding to the main body 2 covers the opening 20. The assembly portion 21 has an axial hole 211 on a top face thereof opposite to the opening 20, and a gap 212 is defined on one side thereof (as shown in FIG. 6). A leading peg 231 is disposed on the bottom case 23 between the assembly portion 21 and the supply portion 22, and a sleeve 233 is disposed on the bottom case 23 in the supply portion 22 for fixing a dental floss roll. The bottom case 23 defines two guiding grooves 232 thereon relative to the assembly portion 21, and further forming a hanging part 234 extending from the supply portion 22, the hanging part 234 defining a hanging hole 235 thereon for hanging the dental floss holder 1 when it is not in use.

The connecting arm 3 used for connecting the main body 2 and the clean portion 7 is hollow interiorly and has two ends, wherein one end is integrally formed with one side of the main body 2 with respect to the gap 212, and the other end has a position member 31, the gap 212 communicating with the hollow interiorly of the connecting arm 3. The position member 31 includes a position slot 311 and a position board 312 located under the position slot 311, whereby the position slot 311 and the position board 312 jointly define an insertion area. The connecting arm 3 has a pillar 301 located at an inner part of the connecting arm 3. A block bar 32 has a barb 321 at one end thereof and an insertion hole 322 at the other end for insertion on the pillar 301. Two first traversing parts 331 are defined respectively on two opposite sides of the connecting arm 3 and spaced apart from the position member 31. The first traversing parts 331 are an elongated narrow shape.

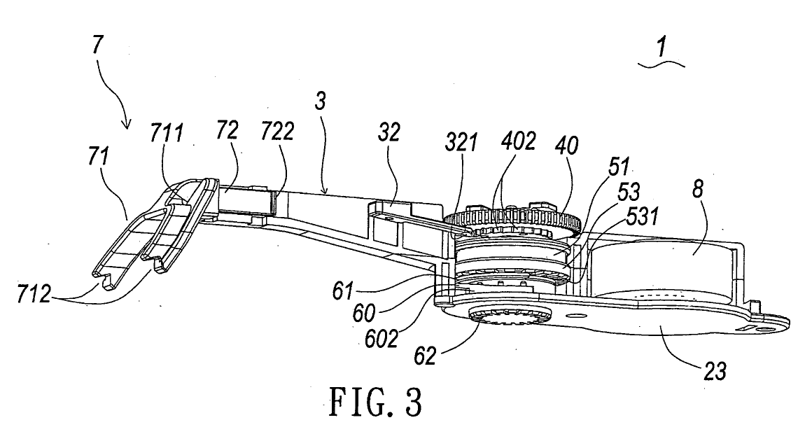

Referring to FIG. 1 in combination with FIG. 3, the restraining apparatus 4 is rotatably mounted on the assembly portion 22, including a spinning wheel 40 with a meshing wheel 402 formed therebeneath (as shown in FIG. 3), a hollow post 41, and a retrieving member 42 disposed on the spinning wheel 40. The spinning wheel 40 has an aperture 401 corresponding to the axial hole 211 of the assembly portion 22. The meshing wheel 402 is of serrated periphery used to engage with the barb 321 of the block bar 32, by which the spinning wheel 40 only can spin in one direction. The hollow post 41 pivotally inserted through the aperture 401 and the axial hole 211. The retrieving member 42 has a retrieving wheel 421 having a rod 423 mounted therebeneath. The rod 423 is coaxial with the hollow post 41 and inserted to the hollow post 41. The retrieving wheel 422 further forms a pair of clips 422 thereon, the clips 422 protruding upward to form a space from the retrieving wheel 421 for retracting dental floss 8 therein. A cutting element 424 is assembled on the clips 422 and has a cutter 425 thereon.

The hollow shaft portion 5 is rotatably mounted to the hollow post 41 in the assembly portion 21, and includes an upper cap 52 and a lower cap 53. The upper cap 52 shrinks inwardly and then extend a fitting portion 521 which is attached by a spool 51 made of soft material; the lower cap 53 forms a plurality of zigzag grooves 531 therebeneath. The spool 51 is covered by the upper cap 52 and lower cap 53 respectively from the top and bottom.

The releasing apparatus 6 is disposed under the hollow shaft portion 5 in the assembly portion 21, including a releasing bar 60, a driven member 61, a rotation wheel 62, and a substrate 63. The releasing bar 60 of arcuate shape has a mounting part 602 having three mounting holes 603 thereon, and a free end being inclined upwardly and forming a protrusion 601, the protrusion 601 being engageable with the zigzag grooves 531. The driven member 61 of circular shape is disposed above the releasing bar 60, wherein a part of the periphery of the driven member 61 protrudes outwardly to form a flange 611 which is able to prop against the releasing bar 60, furthermore, two mating holes 612 are located on the driven member 61 with respect to the guiding grooves 232 of the bottom case 23. The rotation wheel 62 has two linking rods 621 for being inserted into the two mating holes 612. The substrate 63 of circular shape has two arched slots 631 corresponding two the guiding grooves 232 and disposed under the driven member 61. Three fixing pegs 632 are located on the bottom case 23 closed to the substrate 63. Accordingly, the three mounting holes 603 of the releasing bar 60 is mounted on the fixing pegs 632, and the linking rods 621 of the rotation wheel 62 is inserted into the mating holes 612 of the driven member 61 through the guiding grooves 232 and the arched slots 631, whereby the driven member 61 is rotated by the rotation wheel 62 along the arched slots 631.

Further referring to FIG. 1 in combination with FIGS. 2 and 6, the clean portion 7 is used for cleaning teeth and is connected to the connecting arm 3. The clean portion 7 has a pair of U-shaped fork arms 71 and an insertion stem 72 extending rearward from the fork arms 71, the insertion stem 72 having an insertion end 721 for insertion with the position member 31 of the connecting arm 3, wherein the insertion end 721 is interior hollow and further projects outwardly from two opposite sides to from a pair of ribs 722 to against the position slot 311. Furthermore, the fork arms 71 define two second traversing parts 711 on a conjoining end with the insertion stem 72, the second traversing parts 711 spaced apart from the insertion stem 72 and communicating with the first traversing parts 331; the fork arms 71 further define a third traversing part 712 on two ends thereof, the third traversing part 712 being concave shape or being a hole.

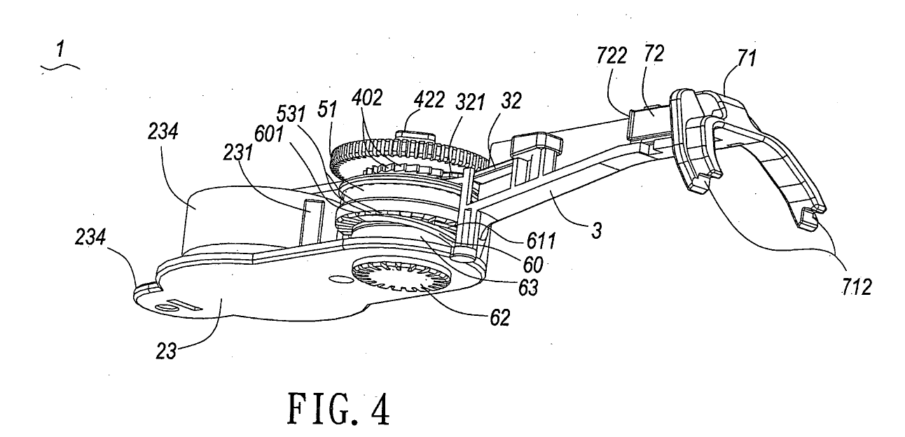

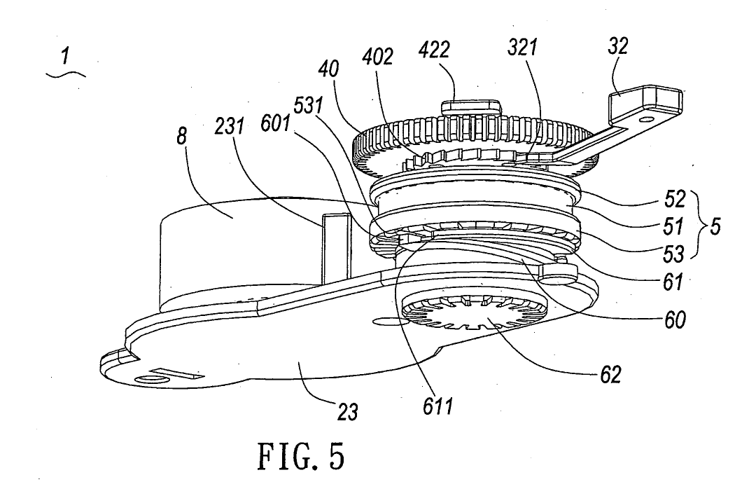

In assembly, first, the spinning wheel 40 of the restraining apparatus 4 is assembled on the assembly portion 21, and then insert the hollow post 41 into the assembly portion 21 from the aperture 401 and the axial hole 211, then assemble the assembled retrieving member 42 on the spinning wheel 40 through which the rob 423 is inserted in the hollow post 41. Secondly, the hollow shaft portion 5 is rotatably mounted to the hollow post 41 in the assembly portion 21, then the next step of assembly comes to the threading of the dental floss 8 in the main body 2, further referring to FIGS. 4 to 6, the dental floss 8 is drawn out of the supply portion 22 and wound around the spool 51 four or five times, whereby the soft material of the spool 51 can increase cohesion with the winding of the dental floss 8 to prevent the dental floss 8 from being loosened as the spinning of the spool 51, and then the dental floss 8 is drawn out of the gap 212 of the assembly portion 21, for now, the threading of the dental floss 8 in the assembly portion 21 is complete. Afterwards, the bottom case 23 with the assembled releasing apparatus 6 is assembled to the opening 20 of the main body 2, in which the protrusion 601 of the releasing bar 60 is in engagement with the zigzag grooves 531 of the hollow shaft portion 5 (as shown in FIG. 4), and the leading peg 231 is against the dental floss 8 to provide a further securing position. The restraining apparatus 4, the hollow shaft portion 5, and the releasing apparatus are in coaxial with one another. Finally, the insertion stem 72 of the clean portion 7 is inserted into the position slot 311 of the position member 31, from which the ribs 722 are wedged by the walls of the position slot 311 and then are engaged with the position slot 311 (as shown in FIG. 6).

Keep referring to FIGS. 4 to 6 to go on the threading of the dental floss 8 in the connecting arm 3 and the clean portion 7. First, rotate the rotation wheel 62 to simultaneously drive the driven member 61 until the driven member 61 is against the releasing bar 60 and therefore to depress the releasing bar 60, whereby the protrusion 601 is disengaged from the zigzag grooves 531, then thread the dental floss 8 through the first traversing part 331 to the second traversing part 711 and along the fork arms 71 to the third traversing part 712; Similarly, threading of the dental floss 8 to the opposite first, second and third traversing parts is carried out in reverse order. The dental floss 8 is finally retracted in and tighten by the clips 422 of the retrieving member 421, and the excess floss can be cut by the cutter 425. Consequently, assembly of the dental floss holder 1 and the dental floss 8 are completed.

In use, the protrusion 601 of the releasing bar 60 is in engagement with the zigzag grooves 531 of the hollow shaft portion 5 in normal state, wherein the dental floss 8 is being tight and unable to be drawn. Accordingly, users can manipulate the fork arms 71 to clean teeth, even rear molar teeth can be cleaned thoroughly. When replace used floss, rotate the rotation wheel 62 to simultaneously drive the driven member 61 until the driven member 61 is against the releasing bar 60 and therefore to depress the releasing bar 60, the floss 8 now is free to be drawn. The used floss segment can be cut away by the cutter 425.

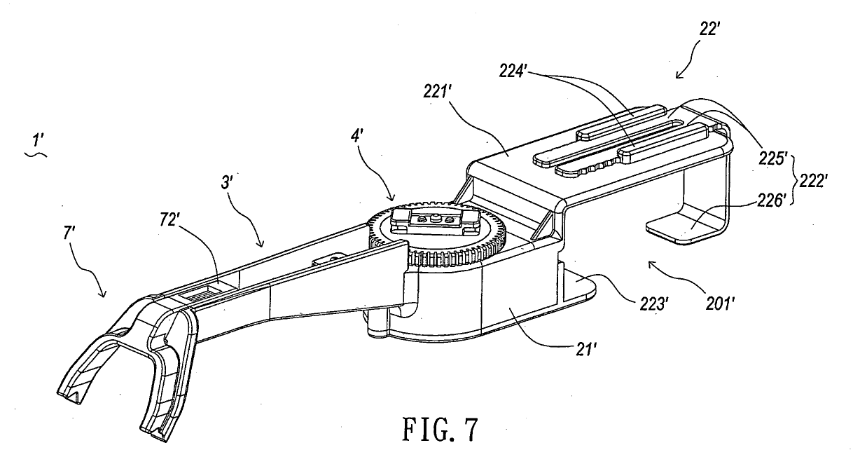

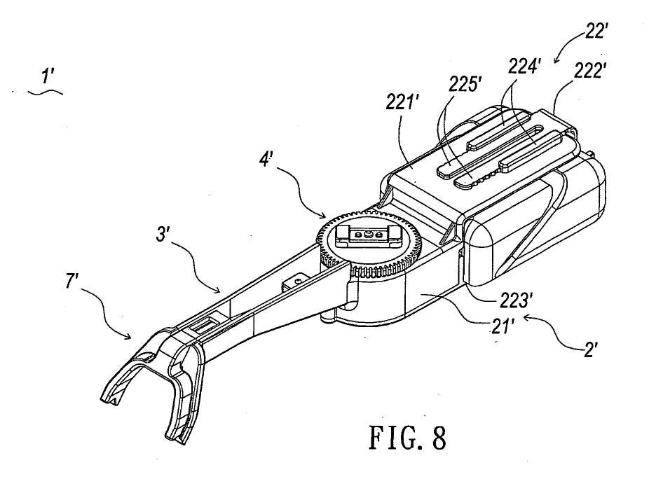

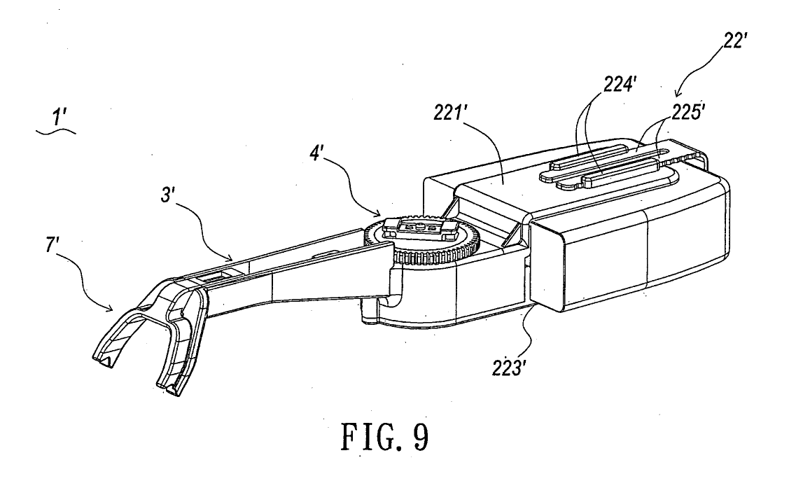

Further referring to FIGS. 7 to 9 for the second embodiment of the present invention, the major differences between the first and the second embodiments are that the supply portion 22′ includes an extending plate 221′ extending from one side of the assembly portion 21, and a holding portion 222′ movably coupled with the extending plate 221′, the bottom case 23 stretching out of the opening 20 to form a support plate 223′, wherein the extending plate 221′, the holding portion 222′ and the support plate cooperatively define a supply area communicating with the assembly portion 21.

The extending plate 221′ has a pair of engaging elements 224′ disposed on a top surface thereof, the engaging elements 224′ forming a L-shaped cross section and having rough faces therein. The holding portion 222′ includes a pair of tabs 225′ having rough edges and movably connected to the engaging elements 224′, and a bending part 226′ extending from the tabs 225′ and jointly forming an inverted U-shaped with the engaging elements 224′. The tabs 225′ are adjustable within the engaging element 224′ in order to accommodate different sizes of dental floss boxes (not labeled), through which use of the dental floss holder becomes more convenient.

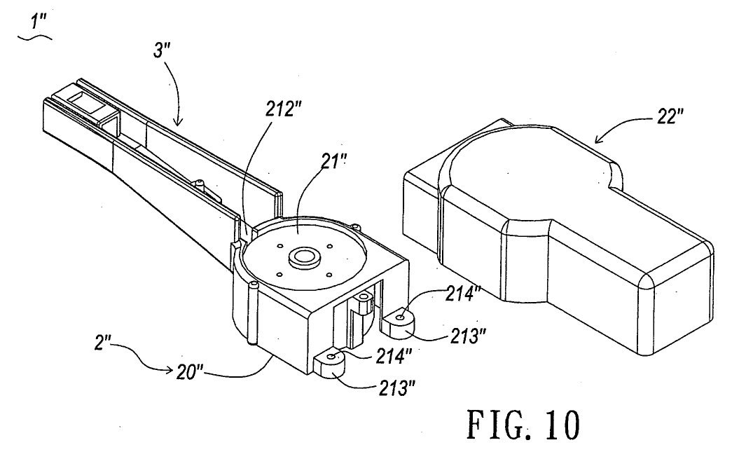

Referring to FIG. 10 of the third embodiment of the present invention, the supply portion 22″ is separated from the assembly portion 21″ of the main body 2″, and the assembly portion 21″ has two fixing portions 213″, each fixing portion 213″ defining a screw hole 214″ thereon. The supply portion 22″ has two mating parts (not displayed) for mating with the two fixing portions 213 by screwing through the screw holes 214″. After assembly, the supply portion 22″ communicates with the assembly portion 21″ where the dental floss 8 is able to thread therethrough.

It is understood that the invention may be embodied in other forms without departing from the spirit thereof Thus, the present examples and embodiments are to be considered in all respects as illustrative and not restrictive, and the invention is not to be limited to the details given herein.

What is claimed is:

1. A dental floss holder with improved structure, comprising:
a main body, being a case of an opening opened downwardly, including an assembly portion assembled and communicating with a supply portion, said assembly portion having an axial hole on a top face thereof opposite to said opening, and a gap defined on one side of said assembly portion, a bottom case covering said opening and defining at least one guiding groove thereon with respect to said assembly portion, said supply portion adapted for accommodating a spool of dental floss;
a connecting arm being hollow interiorly and having two ends, one end connected to one side of said main body with respect to said gap, and the other end having a position member, a block bar disposed on said connecting arm;
a restraining apparatus rotatably mounted on said assembly portion, including:
a spinning wheel having an aperture corresponding to said axial hole, and a meshing wheel formed therebeneath;
a hollow post pivotally inserted through said aperture and said axial hole;
a retrieving member disposed on said spinning wheel and having a retrieving wheel, said retrieving wheel forming a pair of clips thereon, said clips protruding upward to form a space from said retrieving wheel;
a hollow shaft portion rotatably mounted to said hollow post in said assembly portion, said hollow shaft portion attached by a spool and forming a plurality of zigzag grooves therebeneath;
a releasing apparatus disposed under said hollow shaft portion, comprising:
a releasing bar assembled in said assembly portion and having a mounting part mounted on said bottom case, and a free end being inclined upwardly and forming a protrusion, the protrusion being engageable with said zigzag grooves;
a driven member disposed above said releasing bar, a part of said driven member protruding outwardly to be able to prop against said releasing bar;
a rotation wheel having at least a linking rod for connecting said driven member; and
a clean portion having a pair of U-shaped fork arms and an insertion stem extending rearward from the fork arms, the insertion stem having an insertion end for insertion with said position member of said connecting arm;
wherein the floss is drawn out of said gap of said assembly portion to surround along said connecting arm and said fork arms and is then retracted in and tighten by said clips of said retrieving member; while in use, the protrusion of the releasing bar is in engagement with said zigzag grooves of the hollow shaft portion and which enables to clean teeth; while the protrusion disengages from said zigzag grooves, the floss is free to be drawn.

2. The dental floss holder with improved structure according to claim 1, wherein said connecting arm is integrally formed with said main body with respect to said gap.

3. The dental floss holder with improved structure according to claim 1, wherein said connecting arm defines a first traversing part on two sides thereof, said first traversing parts being an elongated narrow shape.

4. The dental floss holder with improved structure according to claim 3, wherein said fork arms defines two second traversing parts on a conjoining portion with said insertion stem, said second traversing parts being spaced by said insertion stem and communicating with said first traversing parts, said fork arms further defining a third traversing part on two ends of said fork arms.

5. The dental floss holder with improved structure according to claim 4, wherein the second traversing part is of elongated narrow shape, and the third traversing part is of concave shape or is a hole.

6. The dental floss holder with improved structure according to claim 1, wherein said position member includes a position slot therein and a position board located under said position slot, whereby the position slot and the position board jointly define an insertion area of a size slightly bigger than said insertion stem.

7. The dental floss holder with improved structure according to claim 6, wherein the insertion stem is interior hollow, and the insertion end further forms a pair of ribs projecting outwardly to against the position slot.

8. The dental floss holder with improved structure according to claim 1, wherein the block bar having a barb at one end thereof for engaging with the meshing wheel of the spinning wheel, and an insertion hole is located at the other end of the block bar, a pillar corresponding to the insertion hole and disposed on the connecting arm.

9. The dental floss holder with improved structure according to claim 1, wherein the driven member is annular and has at least one mating hole thereon for being connected to the linking rod, the annular driven member further protruding to form a flange for contacting against the releasing bar.

10. The dental floss holder with improved structure according to claim 9, wherein the releasing apparatus further including a substrate disposed on the bottom case under the driven member, the substrate being annular and having at least one arched slot corresponding to the guiding groove.

11. The dental floss holder with improved structure according to claim 10, wherein at least one fixing peg is located on the bottom case adjacent to the substrate, the mounting part of the releasing bar having a mounting hole corresponding to the fixing peg.

12. The dental floss holder with improved structure according to claim 1, wherein the retrieving member having a cutting element assembled on the retrieving wheel, the cutting element having a cutter thereon.

13. The dental floss holder with improved structure according to claim 12, wherein the retrieving wheel further has a rod being coaxial with the hollow.

14. The dental floss holder with improved structure according to claim 1, wherein the spool is made of soft material, and the hollow shaft portion further including an upper cap and a lower cap assembled with the upper cap, the upper cap shrinking inwardly to form a fitting portion for fitting the spool, the lower cap forming the zigzag grooves therebeneath.

15. The dental floss holder with improved structure according to claim 1, wherein a leading peg is disposed on the bottom case between the assembly portion and the supply portion, the bottom case further forming a hanging part extending from the supply portion, the hanging part defining a hanging hole thereon.

16. The dental floss holder with improved structure according to claim 1, wherein a sleeve is disposed on the bottom case in the supply portion for fitting the dental floss.

17. The dental floss holder with improved structure according to claim 1, wherein the supply portion includes an extending plate extending from one side of the assembly portion, and a holding portion movably coupled with the extending plate, the bottom case further extending a support plate, whereby the extending plate, the holding portion and the support plate cooperatively define a supply area for accommodating a dental floss box.

18. The dental floss holder with improved structure according to claim 17, wherein the extending plate has a pair of engaging elements thereon, the holding portion including a pair of tabs movably connected to the engaging elements, and a bending part extending from the tabs and jointly forming an inverted U-shaped with the engaging elements, the tabs being adjustable within the engaging element to accommodate different sizes of dental floss boxes.

19. A dental floss holder with improved structure, comprising:
a main body, being a case of an opening opened downwardly, including an assembly portion having an axial hole on a top face thereof opposite to said opening, and a gap defined on one side of said assembly portion, a bottom case covering said opening and extending a support plate;
a supply portion assembled with said assembly portion and having an extending plate extending from one side of the assembly portion, and a holding portion movably coupled with said extending plate, said extending plate, said holding portion and said support plate cooperatively defining a supply area which communicates with said assembly portion;
a connecting arm being hollow interiorly and having two ends, one end connected to one side of said main body with respect to said gap, and the other end having a position member, a block bar disposed on said connecting arm;
a restraining apparatus rotatably mounted on said assembly portion, including:
a spinning wheel having an aperture corresponding to said axial hole, and a meshing wheel formed therebeneath;
a hollow post pivotally inserted through said aperture and said axial hole;
a retrieving member disposed on said spinning wheel;
a hollow shaft portion rotatably mounted to said hollow post in said assembly portion, said hollow shaft portion attached by a spool made of a soft material, and forming a plurality of zigzag grooves therebeneath;
a releasing apparatus disposed under said hollow shaft portion, comprising:
a releasing bar assembled in said assembly portion and having a mounting part mounted on said bottom case, and a free end being inclined upward and forming a protrusion, the protrusion being engageable with said zigzag grooves;
a driven member disposed above said releasing bar, a part of said driven member protruding outwardly to be able to prop against said releasing bar;
a rotation wheel having at least a linking rod for connecting said driven member; and
a clean portion having a pair of U-shaped fork arms and an insertion stem extending rearward from the fork arms for insertion with said position member of said connecting arm;
wherein the floss is drawn out of said gap of said assembly portion to surround along said connecting arm and said fork arms and is then retracted in and tighten by said retrieving member; while in use, the protrusion of the releasing bar is in engagement with said zigzag grooves of said hollow shaft portion and which enables to clean teeth; while the protrusion disengages from said zigzag grooves, the floss is free to be drawn.

20. The dental floss holder with improved structure according to claim 19, wherein the extending plate has a pair of engaging elements thereon, the holding portion including a pair of tabs movably connected to the engaging elements, and a bending part extending from the tabs and jointly forming an inverted U-shaped with the engaging elements, the tabs being adjustable within the engaging element to accommodate different sizes of dental floss boxes.
